(19) United States
(12) Patent Application Publication
(10) Pub. No.: US 2024/0424605 A1
(43) Pub. Date: Dec. 26, 2024

(54) APPARATUS FOR CUTTING A SHEET OF AEROSOL-GENERATING MATERIAL

(71) Applicant: NICOVENTURES TRADING LIMITED, London (GB)

(72) Inventors: Scott PARK, London (GB); Gary FALLON, London (GB); Geoffrey FOSS-SMITH, London (GB)

(21) Appl. No.: 18/700,862

(22) PCT Filed: Oct. 12, 2022
(86) PCT No.: PCT/GB2022/052576

§ 371 Date: Apr. 12, 2024

(30) Foreign Application Priority Data
Oct. 12, 2021 (GB) 2114604.8

(51) Int. Cl. B23K 26/08; B23K 26/38

(52) U.S. Cl. CPC B23K 26/0838; B23K 26/38

(57) ABSTRACT

An apparatus for cutting a sheet of aerosol-generating material includes a laser generator configured such that a laser emitted by the laser generator cuts the sheet as the sheet of aerosol-generating material is conveyed along a conveyance path. An apparatus for manufacturing a sheet of aerosol-generating material including the apparatus for cutting a sheet of aerosol-generating material is also disclosed. Also disclosed is a consumable having a sheet of aerosol-generating material formed into a wrapped rod and having a distal end for insertion into an aerosol generating device including a heating element that is received within the aerosol-generating material at the distal end of the rod. A portion of the sheet of aerosol generating material at the distal end of the rod is cut into strips extending from said distal end of the wrapped rod.

### RELATED APPLICATIONS

The present application is a National Phase entry of PCT Application No. PCT/GB2022/052576 filed Oct. 12, 2022, which claims priority to GB Application No. 2114604.8 filed Oct. 12, 2021, each of which is hereby incorporated by reference in their entirety.

### TECHNICAL FIELD

The present disclosure relates to apparatus for cutting a sheet of aerosol-generating material, to apparatus for manufacturing a sheet of aerosol-generating material, to apparatus and a method for manufacturing an aerosol-generating consumable, to a sheet of aerosol-generating material wound onto a bobbin, to a consumable comprising a sheet of aerosol-generating material, and to a non-combustible aerosol provision system comprising the consumable of the invention and an aerosol generating device.

### BACKGROUND

Certain tobacco industry products produce an aerosol during use, which is inhaled by a consumer. For example, tobacco-heating devices heat an aerosol-generating material such as tobacco to form an aerosol by heating, but not burning, the aerosol-generating material. During manufacture, a sheet or web of aerosol-generating material is unwound from a bobbin and fed into a consumable forming unit which gathers the sheet or web into a rod, wraps the rod in a wrapper and cuts the rod into rod sections each of which form an individual consumable. The sheet may be cut into strips or strands prior to being gathered into a rod.

### SUMMARY

In accordance with some embodiments described herein, there is provided apparatus for cutting a sheet of aerosol-generating material comprising a laser generator configured such that a laser emitted by the laser generator cuts the sheet as the sheet of aerosol-generating material is conveyed along a conveyance path.

The apparatus may comprise a control unit configured to control the laser generator.

The control unit may be configured to control the laser generator to cut the sheet of aerosol-generating material into a plurality of continuous, parallel, elongate strips of aerosol-generating material that extend in a direction along the conveyance path.

The control unit may be configured to control the laser generator to intermittently cut the sheet of aerosol-generating material to form discrete cut sections spaced from each other in a direction extending along the conveyance path.

Each discrete cut section may comprise a plurality of parallel, elongate strips of aerosol-generating material extending in a direction along the conveyance path.

The control unit may be configured to control the laser generator to form a registration mark in the sheet of aerosol-generating material.

The registration mark may be at least one cut or perforation in the sheet separate from said discrete cut sections.

Each registration mark may be a pattern of cuts, perforations or other indicia formed in the sheet.

The control unit may be configured to form the registration mark between, or adjacent to, discrete cut sections.

In accordance with some other embodiments described herein, there is provided apparatus for manufacturing a sheet of aerosol-generating material comprising apparatus for cutting a sheet of aerosol-generating material according to the invention.

The apparatus may comprise a sheet of aerosol-generating material manufacturing unit and, a winding unit for winding the manufactured sheet onto a bobbin. The apparatus for cutting a sheet of aerosol generating material may be configured to cut the sheet prior to winding of the sheet onto a bobbin using the winding unit.

In accordance with some other embodiments described herein, there is provided apparatus for manufacturing an aerosol-generating consumable from a sheet of aerosol-generating material, the apparatus comprising:
a conveyor to convey a sheet of aerosol-generating material along a conveyance path,
a laser generator configured such that a laser emitted by the laser generator cuts the sheet of aerosol-generating material as the sheet of aerosol-generating material is conveyed along the conveyance path, and
a consumable forming unit to receive the cut sheet of aerosol-generating material as it is conveyed along the conveyance path and form it into a rod-like shape.

The apparatus may comprise a control unit configured to control the laser generator to cut the sheet into a plurality of parallel, elongate strips of aerosol-generating material that extend longitudinally in a direction extending along the conveyance path.

The apparatus may comprise a control unit configured to control the laser generator to intermittently cut the sheet to form discrete cut sections, each cut section being spaced from an adjacent cut section in a direction extending along the conveyance path.

Each discrete cut section may comprise a plurality of parallel, elongate strips of aerosol-generating material extending in a direction along the conveyance path.

The control unit may be configured to control the laser generator to form a registration mark in the sheet.

The apparatus may comprise a scanner configured to read a registration mark and send a signal indicative of the presence of a registration mark to the control unit.

The control unit may be configured to control the consumable forming unit in dependence on said signal.

The consumable forming unit may comprise a garniture to wrap the sheet formed into a rod-like shape in a wrapper to form a wrapped rod, and a cutter to cut the wrapped rod into discrete rod sections.

The control unit may be configured to control the cutter that cuts the wrapped rod into discrete rod sections in dependence on said signal indicative of the presence of a registration mark.

The control unit may be configured to control the cutter in dependence on said signal such that a discrete cut section extends from an end of each of said discrete rod sections.

The apparatus may comprise a feeding unit to receive a bobbin of aerosol-generating sheet and for unwinding said aerosol-generating sheet from the bobbin and to feed said sheet along said conveyance path.

In accordance with some other embodiments described herein, there is provided a sheet of aerosol-generating material wound onto a bobbin, the sheet comprising a plurality of parallel, elongate strips of aerosol-generating material that extend in a direction along the length of the sheet.

The plurality of parallel, elongate strips may be formed in discrete cut sections spaced from each other along the length of the sheet.

The sheet of aerosol-generating material may comprise a laminate of two or more layers. One of the layers can be a gel. The gel may include or be formed from a flavorant such as menthol.

In accordance with some other embodiments described herein, there is provided a consumable comprising a sheet of aerosol-generating material formed into a wrapped rod and having a distal end for insertion into an aerosol generating device comprising a heating element that is received within the aerosol-generating material at distal end of the rod, wherein a portion of the sheet of aerosol generating material at the distal end of the rod is cut into strips extending from said distal end of the wrapped rod. As previously indicated, the sheet of aerosol-generating material may comprise a laminate. One layer of the laminate may be a gel and be formed from, or contain, a flavorant such as menthol.

In accordance with another aspect of the invention, there is provided a non-combustible aerosol provision system comprising the consumable of the invention, and an aerosol generating device comprising a heating element. The aerosol-generating device is configured to receive the consumable such that the heating element is received within the aerosol-generating material at the distal end of the rod.

In accordance with some other embodiments described herein, there is provided a method of cutting a sheet of aerosol-generating material comprising:
conveying a sheet of aerosol-generating material along a conveyance path, and
making cuts in the sheet using a laser emitted by a laser generator as the sheet is conveyed along the conveyance path.

The method may comprise using a control unit to control the laser generator to make cuts in the sheet to form a plurality of continuous, parallel, elongate strips of aerosol-generating material that extend in a direction along the conveyance path.

The method may comprise using a control unit control the laser generator to make cuts in the sheet to form discrete cut sections spaced from each other in a direction extending along the conveyance path, each discrete cut section comprising a plurality of parallel, elongate strips of aerosol-generating material.

According to the invention, there is also provided a sheet of aerosol-generating material cut according to the method referred to above.

In accordance with some other embodiments described herein, there is provided a method of manufacturing an aerosol-generating consumable from a sheet of aerosol-generating material, the method comprising:
conveying a sheet of aerosol-generating material along a conveyance path,
cutting the sheet of aerosol-generating material using a laser emitted by a laser generator as the sheet of aerosol-generating material is conveyed along the conveyance path, and
forming the cut sheet into a consumable in a consumable forming unit.

The method of manufacturing an aerosol-generating consumable may comprise cutting the sheet using the laser generator to form discrete cut sections spaced from each other in a direction extending along the conveyance path, and so that each discrete cut section comprising a plurality of parallel, elongate strips of aerosol-generating material.

Forming the cut sheet into a consumable may comprise forming the sheet into a rod, wrapping the rod with a wrapping material and cutting the rod into discrete cut rods.

The method may comprise cutting the rod into discrete rods such that a discrete cut section extends from the end of each rod.

According to the invention, there is also provided an aerosol-generating consumable produced according to the method referred to above.

In accordance with other aspects of the invention, there is provided a sheet of aerosol-generating material cut using a laser emitted by a laser generator as the sheet is conveyed along a conveyance path.

In accordance with yet further aspects of the invention, there is provided an aerosol-generating consumable formed from the sheet of aerosol-generating material according to the invention.

### BRIEF DESCRIPTION OF THE DRAWINGS

Embodiments will now be described, by way of example only, with reference to the accompanying drawings, in which:

FIG. 1 is a schematic drawing of an embodiment of an apparatus for manufacturing a a consumable according to an embodiment of the present invention;

FIG. 2 is a schematic drawing of an embodiment of an apparatus for manufacturing a consumable according to another embodiment of the present invention;

FIG. 3 is a schematic drawing of an embodiment of an apparatus for manufacturing a consumable according to yet another embodiment of the present invention;

FIGS. 4A to 4C are different representations of a sheet of aerosol-generating material which have been cut using the apparatus of FIG. 1, 2 or 3, and prior to being formed into a consumable;

FIG. 5 shows an aerosol provision device in which a consumable according to embodiments of the invention is received, and

FIG. 6 is a flow diagram to illustrate a method of manufacturing a consumable for an aerosol provision device according to an embodiment of the present invention.

### DETAILED DESCRIPTION

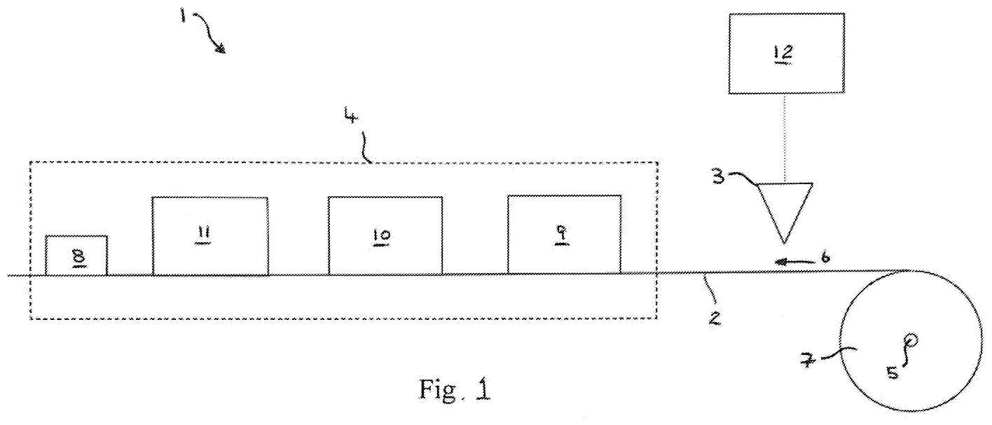

FIG. 1 is a schematic drawing of an embodiment of an apparatus 1 for manufacturing an aerosol-generating consumable from a sheet of aerosol-generating material 2 according to a first embodiment. The manufacturing apparatus 1 includes cutting apparatus 3 for cutting the sheet of aerosol-generating material 2, prior to conveyance of the sheet of aerosol-generating material 2 into a consumable forming unit 4 of the manufacturing apparatus 1.

In each embodiment of the invention, the sheet of aerosol-generating material 2 is a tobacco material, for example, a reconstituted tobacco material that is formed into a continuous web or sheet. However, it should be recognised that the aerosol-generating material 2 may alternatively be a non-tobacco based material.

The manufacturing apparatus 1 comprises a feeding apparatus 5 which mounts a spool or bobbin 7 of aerosol-generating material. The feeding apparatus 5 is configured to supply the sheet 2 of aerosol-generating material as a continuous sheet along a conveyance path 6. The sheet 2 may be fed along the conveyance path 6 by any suitable mechanism, for example, a drive belt or a plurality of rollers (not shown), at least one of which is driven.

The consumable forming unit 4 of the manufacturing apparatus 1 is configured to receive the sheet 2 of aerosol-generating material as it is conveyed along the conveyance path 6. The consumable forming unit 4 is configured to form the sheet 2 into a consumable 8. In the present example, the consumable forming unit 4 is configured to gather or otherwise form the sheet 2 of aerosol-generating material into an elongate, continuous rod in rod-forming unit 9, and to wrap the continuous rod in wrapping material in a wrapping unit 10 before subsequently cutting the elongate wrapped rod in a rod cutter 11, into discrete rod sections 8, each of which may form an individual consumable 8, as shown in FIG. 1.

In some consumables, the sheet 2 is in the form of strips or strands that extend in a longitudinal direction along the length of the consumable 8 and in a direction that extends along the conveyance path 6 during manufacture. To enable this construction, it is known to cut the sheet 2 into a plurality of longitudinal strips or strands, which may be in the order of 1 mm wide, using a cutting cylinder incorporating cutting blades which act on the sheet 2 and cut it prior to entry of the cut sheet into the consumable forming unit 4 that gathers and forms the strips into a rod and which wraps the rod in a wrapping material.

A problem with the aforementioned cutting technique is that a substantial amount of tobacco dust is produced. The dust coats or sticks to both the strands and the apparatus. Often, this problem is mitigated by providing a dust extraction system to either vacuum, or blow, the dust off the strands and the apparatus. However, this adds additional complexity to the apparatus and some dust will still remain. The dust may also be blown into the local area surrounding the apparatus. Another concern is that cutting blades provide a less than precise cut and, due to a lack of uniformity in the thickness of the sheet, can result in the snapping of individual strands.

To alleviate or substantially overcome the aforementioned problems, the sheet 2 is cut into strips using a laser generator 3, which can provide a more precise and much cleaner cut, thereby avoiding or minimising dust. The likelihood of individual strands snapping or breaking is also prevented or reduced, as the strands maintain a greater tensile strength when cut by a laser emitted by a laser generator 3.

In an embodiment, the laser generator 3 is positioned above the aerosol-generating sheet 2 between the feeding apparatus 5 and the consumable forming unit 4 such that a laser emitted by the laser generator 3 will cut the sheet 2 of aerosol-generating material as it is conveyed along the conveyance path 6 and before it reaches the consumable forming unit 4. The laser generator 3 may be positioned so that the sheet 2 is cut into strands immediately after it is unwound from the bobbin 7 mounted on the feeding apparatus 5. Alternatively, the sheet 2 may be cut further downstream, i.e. just prior to entry into the consumable forming unit 4. A suitable laser generator is manufactured by Micro Laser Tech® 2×400 W, model MLS-G 2-800 or MPS-M 4-800.

The sheet 2 is cut into strands on-line, i.e. as the sheet 2 is unwound from the bobbin 7 and fed into the consumable forming unit 4 of a consumable manufacturing apparatus 1. However, it will be appreciated that the sheet 2 could also be pre-cut, i.e. the cuts in the sheet 2 could be formed as an integral part of the sheet manufacturing process. In this case, the manufactured sheet 2 is cut immediately after manufacture and before it is wound onto a bobbin 7 which is then subsequently mounted to the feeding unit 5 of the apparatus 1 for manufacturing the consumable. The sheet 2 is therefore wound onto the bobbin 7 in its cut form and the cutting apparatus comprising a laser generator 3 according to an embodiment of the invention can be located between the sheet manufacturing apparatus 1 and apparatus that winds the sheet onto a bobbin 7.

The sheet 2 may also be cut in an independent process on a dedicated cutting machine. For example, an uncut sheet 2, which has been wound onto a spool 7 following manufacture, may subsequently be mounted to a cutting machine which unwinds the sheet from the spool 7, cuts it using a laser generator, before winding the cut sheet 2 back onto another spool 7. The laser generator 3 for cutting the sheet 2 may be mounted so that a laser generator cuts that portion of the sheet 2 which is between the two spools 7.

It will also be understood that, in an alternate embodiment, the feeding apparatus 5 can supply individual sheets of aerosol-generating material 2 along the conveyance path 6, with the laser generator 3 positioned so as to make cuts in each sheet, rather than in a continuous length of aerosol-generating material unwound from a bobbin 7.

The rod-forming unit 9 of the consumable forming unit 4 is configured to gather the sheet 2 of aerosol-generating material cut by the laser generator 3 and form them into a rod-like shape, which may have a generally circular shaped cross-section, although other cross-sectional shapes are envisaged. The rod-forming unit 9 may comprise a funnel or cone (not shown) that is configured to gather the strips together such that the strips exit the funnel or cone as a rod.

The wrapping unit 10 is downstream of the rod-forming unit 9, and is configured to wrap the gathered strips of aerosol-generating material in a wrapper. The wrapping unit may comprise a garniture (not shown) that is configured to receive the rod of gathered strips and wrap the strips in the wrapper. The wrapper may be fed as a continuous web through the garniture on a garniture belt (not shown) that is configured to wrap around the rod of strips as the belt, wrapper and strips pass through a narrowing cone or tongue of the garniture. The wrapper may then be secured in position using adhesive that is applied or pre-applied to an edge of the wrapper.

The consumable forming apparatus 4 also comprises a rod cutter 11 located downstream of the wrapping unit 10. The rod cutter 11 is configured to cut the continuous wrapped rod into discrete rods 8 of aerosol-generating material. The discrete rods 8 produced by the rod cutter 11 may be single-length or double-length rods, or longer.

The laser generator 3 can have an array of laser generating heads mounted in a fixed position to simultaneously cut the sheet 2 into a plurality of strips as the sheet 2 is conveyed along the conveyance path 6 such that the strips extend in a direction along the conveyance path 6. However, one or more of the laser generating heads may be movable so as to scan across the sheet 2. It is envisaged that the sheet 2 will continue to move along the conveyance path 6. However, it is also possible for the sheet 2 to move intermittently so that it is held stationary whilst being cut by the laser generator 3.

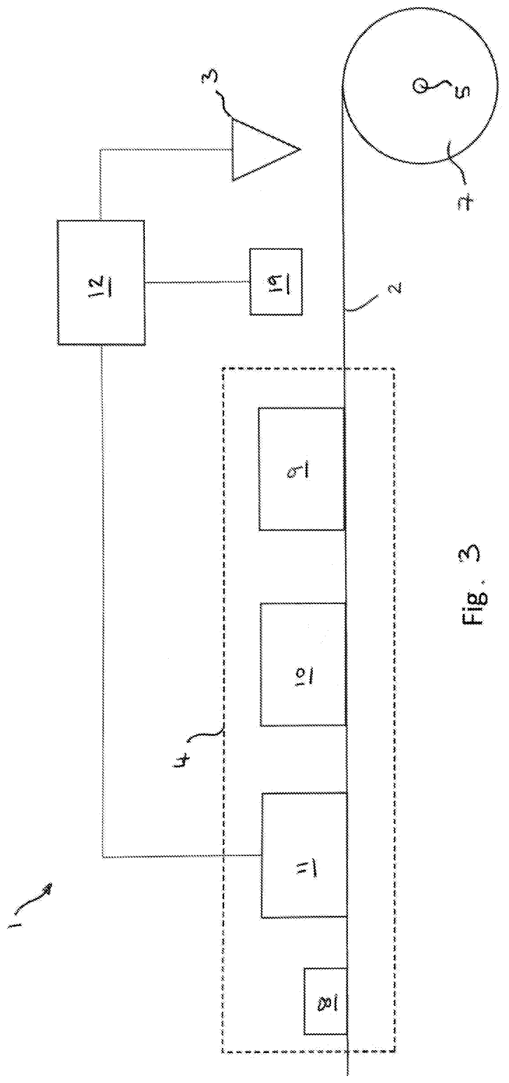

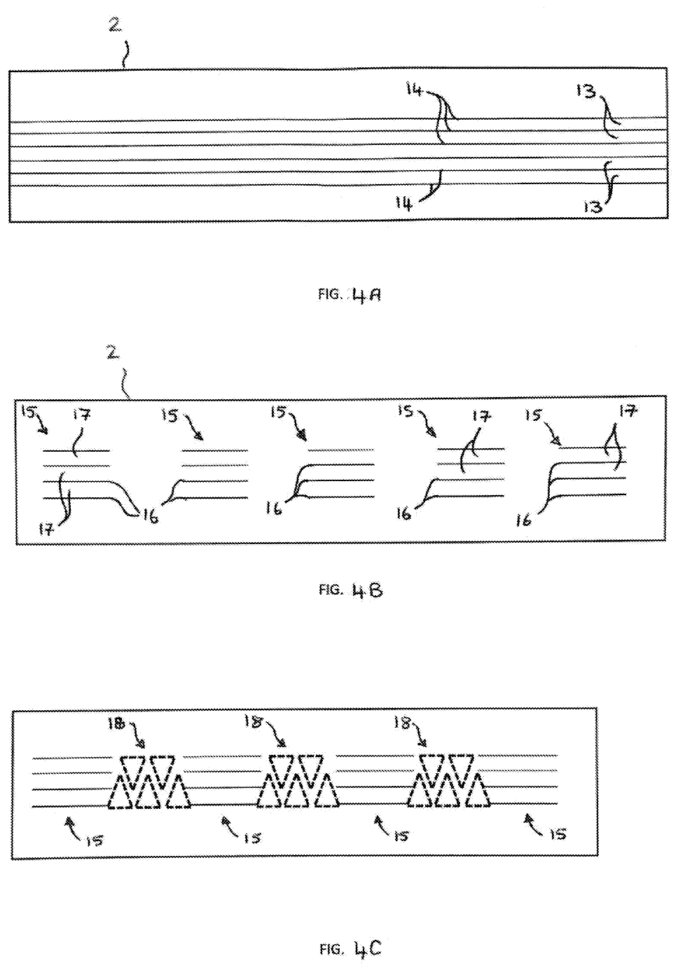

The apparatus 1 may include a control unit 12 operable to control activation of the laser generator 3. In some embodiments, such as that shown in FIG. 1, the control unit 12 may control the laser generator 3 such that the laser generator 3 remains active in order to cut the sheet 2 continuously as the sheet 2 moves along the conveyance path 6. FIG. 4A illustrates a plan view of a portion of a sheet 2 of aerosol-generating material which has been cut into a series of continuous, longitudinally extending parallel strips 13 by the laser generator 3 of FIG. 1. In the drawing of FIG. 3A, six cuts 14 have been made in the sheet to form five strips 13. However, it will be understood that the sheet 2 may be cut into any number of strips 13, and that it may be cut into strips 13 across the full width of the sheet 2. In a modified embodiment, the control unit 12 may be omitted altogether and the laser generator 3 may be manually controlled, i.e. via an on/off switch, or it may operate in conjunction with operation of the feeding unit 5.

In an alternate embodiment, and as shown in the plan view of a portion of a sheet of aerosol-generating material 2 of FIG. 4B, the control unit 12 may continuously activate and deactivate the laser generator 3 of FIG. 1 as the sheet 2 continues to travel along the conveyance path 6, such that the sheet 2 is cut intermittently to form discrete cut sections 15 spaced from each other in a direction extending along the conveyance path 6. In FIG. 4B, each discrete cut section 15 comprises four spaced, parallel, cuts 16 to form three strips 17. As with FIG. 4A, each discrete cut section 15 may comprise any number of cuts 16 adjacent to each other and extending across the width of the sheet 2. A sheet 2 provided with discrete cut sections 15, such as those shown in FIG. 4B, may be preferred if the sheet 2 is to be cut prior to it being wound onto a bobbin 7, as the intermittent cut sections 15 provide additional strength and maintain the overall integrity of the sheet 2 and make it easier to unwind when the bobbin 7 is mounted on the consumable manufacturing apparatus 1. If the sheet is pre-cut with discrete cut sections 15, the laser generator 3 may also be used to cut a registration mark 18 in the sheet 2 between or adjacent to the discrete cut sections 15, as shown in the plan view showing a portion of a sheet of aerosol-generating material 2 of FIG. 4C.

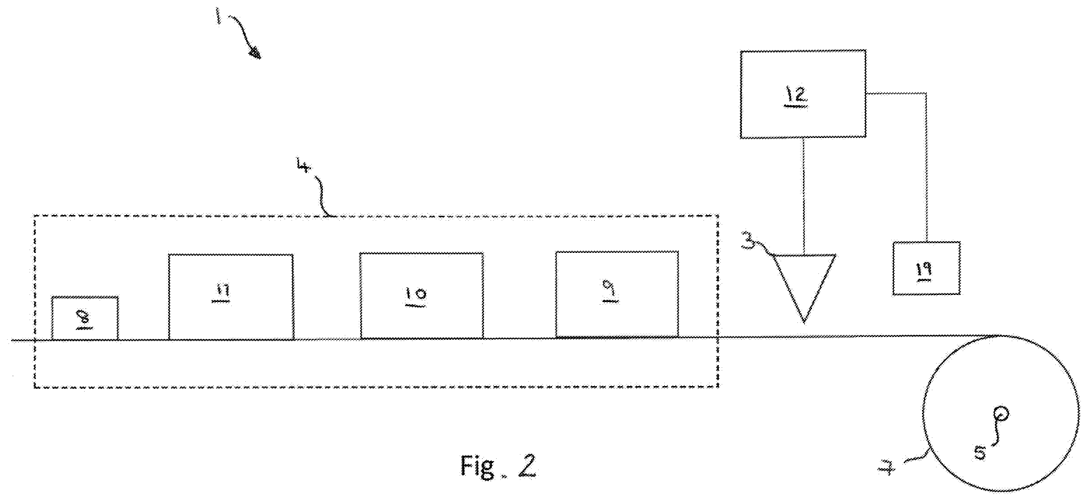

When the sheet 2 is subsequently unwound and fed along the conveyance path 6 into the consumable forming unit 4, additional cuts may be made in the web to form continuous longitudinal strips 13, so the sheet 2 appears as it does in FIG. 4A. These additional cuts may be made using a laser generator 3 or, by a conventional cutting blade. Although the use of a conventional cutting blade will result in some dust being generated, the extent of the cuts that need to be made will be much shorter than the any cuts made to a previously uncut sheet, and so the amount of dust will be substantially reduced. Operation of the laser generator 3, or a conventional cutting blade, may be controlled in response to a signal received from a scanner 19 (see FIG. 2) located upstream of the cutter and which reads the registration mark 18 on the sheet 2 and operates the cutter 3 to complete the cuts between the discrete cut sections 15.

The registration mark 18 may be a pattern or image that can be read by the scanner 19 on the manufacturing apparatus 1, and which is capable of sending a signal to control the cutter 3 to complete any cuts between the discrete cut sections 15 of the sheet 2 before the sheet 2 enters the consumable forming unit 4. The registration mark 18 may be formed using the laser 3 at reduced intensity so as not to penetrate all the way through the sheet 2, and/or used intermittently so as to form a series of perforations in the sheet 2.

In the illustrated embodiment of FIG. 4C, the registration mark 18 is located between the discrete cut sections 15 and comprises a series of interlocking triangles, but the registration mark 18 can be formed from any individual shape or combination of shapes. The registration mark 18 can also be positioned elsewhere, i.e. adjacent to the discrete cut sections 15 or offset to one side of the region between the discrete cut sections 15.

As the sheet 2 travels along the conveyance path 6, the scanner 19 reads or recognises the registration mark 18 and sends a signal to the control unit 12 which then activates and deactivates a cutter, whether that be a laser generator 3 or a conventional cutting unit, to complete the cuts between the discrete cut sections 15 to form a plurality of continuous longitudinally extending strips, as shown in FIG. 3A, before said strips enter the consumable forming unit 4.

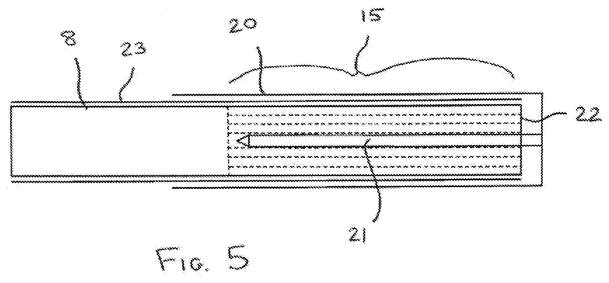

In another embodiment, the discrete cut sections 15 and registration mark 18 may be cut into the sheet 2 using the laser generator 3, as shown in FIG. 3, and there may be no further cutting of the sheet 2 between the discrete cut sections 15 prior to entry of the sheet 2 into the rod forming unit 9. In this embodiment, the control unit 12 may instead be configured to control the rod cutter 11 that cuts the rod into discrete rods sections 8, in dependence on the signal received from the scanner 19 that reads the registration mark 18. In particular, the rod cutter 11 may be controlled so that the rod is cut into discrete rod sections 8 so that a discrete cut section 15 extending from one end of each discrete rod section 8, and which forms a distal end of the consumable, i.e. the end of the consumable, opposite to a mouth end, which is inserted into an aerosol-generating device 20 (see FIG. 5) for heating the aerosol-generating material of the consumable during use.

If the aerosol-generating sheet 2 is pre-cut with the discrete cut sections 15 and the registration mark 18, then the laser generator 3 may be omitted altogether from the embodiment shown in FIG. 3. The scanner 19 then recognises the registration mark 19 and the control unit 12 controls the rod cutter 11 as described in the previous paragraph.

If the aerosol-generating device 20 (see FIG. 5) into which the consumable 8 is inserted has a heating element 21 in the form of a pin or blade that is inserted into the distal end 22 of the consumable 8, the discrete cut section 15 extending from that end of the consumable 8 may facilitate the insertion of the heating element 21. The discrete cut section 15 may be the same length as the heating element 21 which is to be inserted to it. Alternatively, each discrete cut section 15 may be shorter or longer than the length of the heating element 21.

In the above embodiments, the scanner 19 may be arranged perpendicular to the conveyance path 4 or at an angle to the conveyance path 4 above the sheet of aerosol-generating material 2. The scanner 19 may comprise a camera. Any suitable model of camera can be used, for example, the Keyence (TM) CA-HL02MX camera. A camera is configured to image the sheet 2 of aerosol-generating material as it passes along the conveyance path 4 and to detect the presence of a registration mark 18.

With further reference to FIG. 5, the aerosol-generating device 20 is a non-combustible aerosol-generating device 20. An aerosol-generating system comprises a consumable 8 according to embodiments of the invention together with the aerosol-generating device 20. As represented by the dashed lines in FIG. 5, the aerosol-generating material 2 gathered into a rod and wrapped in wrapping material 23 has a discrete cut section 15 extending from the end of the consumable 8 that is inserted into the aerosol-generating device 20, such that the heater element 21 within the device 20 is received in the aerosol-generating material formed by the discrete cut section 15.

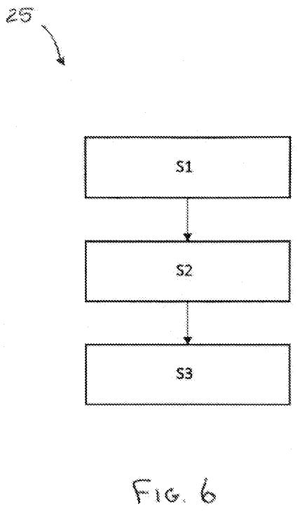

Referring now to FIG. 6, a flowchart to illustrate a method 25 of manufacturing a consumable 8 for an aerosol-provision device 20 is illustrated. The method 25 comprises feeding a sheet of aerosol-generating material 2 along a conveyance path (step S1); cutting the sheet of aerosol-generating material 2 using a laser emitted by a laser generator 3 as the aerosol-generating sheet 2 is conveyed along the conveyance path (step S2), and forming the cut sheet 2 into a consumable 8 in a consumable forming unit 4 (step S3).

The step (step S2) of cutting the sheet of aerosol-generating material 2 using a laser generator 3 may comprise cutting it to form discrete cut sections 15 spaced from each other in a direction extending along the conveyance path 6, and so that each discrete cut section 15 comprises a plurality of parallel, elongate strips of aerosol-generating material 2.

The step of forming the cut sheet into a consumable 8 in a consumable forming unit 4 (step S3) may comprise forming the sheet 2 into a rod, wrapping the rod with a wrapping material and cutting the rod into discrete cut rods with a rod cutter 11.

The step of forming the cut sheet into a consumable 8 in the consumable forming unit 4 (step S3) may also comprise cutting the rod into discrete rods 8 using the rod cutter 11 such that a discrete cut section 15 extends from an end of each rod.

According to the present disclosure, an “aerosol-generating device”, and aerosol-generating system” refer to a non-combustible aerosol provision device, and a non-combustible aerosol-generating system, respectively.

According to the present disclosure, a “non-combustible” aerosol provision device or system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may or may not contain nicotine. The aerosol-generating material may comprise, for example, tobacco or a non-tobacco product.

In some embodiments, the non-combustible aerosol provision device may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable 8 for use with the non-combustible aerosol provision device may comprise, in addition to aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material 2 may be a laminate of 2 or more layers. One layer may be a gel layer and can include or be formed from a substance or flavorant such as menthol. The laminate may be formed as part of the bandcast process such that the laminate is wound onto a bobbin.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in the future.

1. Apparatus for cutting a sheet of aerosol-generating material comprising:
a laser generator configured such that a laser emitted by the laser generator cuts the sheet as the sheet of aerosol-generating material is conveyed along a conveyance path.

2. Apparatus according to claim 2, comprising a control unit configured to control the laser generator.

3. Apparatus according to claim 2, wherein the control unit is configured to control the laser generator to cut the sheet of aerosol-generating material into a plurality of continuous, parallel, elongate strips of aerosol-generating material that extend in a direction along the conveyance path.

4. Apparatus according to claim 2, wherein the control unit is configured to control the laser generator to intermittently cut the sheet of aerosol-generating material to form discrete cut sections spaced from each other in a direction extending along the conveyance path.

5. Apparatus according to claim 4, wherein each discrete cut section comprises a plurality of parallel, elongate strips of aerosol-generating material extending in a direction along the conveyance path.

6. Apparatus according to claim 4, wherein the control unit is configured to control the laser generator to form a registration mark in the sheet of aerosol-generating material.

7. Apparatus according to claim 6, wherein said registration mark is at least one cut or perforation in the sheet separate from said discrete cut sections.

8. Apparatus according to claim 7, wherein each registration mark is a pattern of cuts, perforations or other indicia formed in the sheet.

9. Apparatus according to claim 7, wherein said control unit is configured to form the registration mark between, or adjacent to, discrete cut sections.

10. Apparatus for manufacturing a sheet of aerosol-generating material comprising apparatus for cutting a sheet of aerosol-generating material according to claim 1.

11. Apparatus according to claim 10, comprising a sheet of aerosol-generating material manufacturing unit and, a winding unit for winding the manufactured sheet onto a bobbin, the apparatus for cutting a sheet of aerosol generating material being configured to cut the sheet prior to winding of the sheet onto a bobbin using the winding unit.

12. Apparatus for manufacturing an aerosol-generating consumable from a sheet of aerosol-generating material, the apparatus comprising:
a conveyor to convey a sheet of aerosol-generating material along a conveyance path,
a laser generator configured such that a laser emitted by the laser generator cuts the sheet of aerosol-generating material as the sheet of aerosol-generating material is conveyed along the conveyance path, and
a consumable forming unit to receive the cut sheet of aerosol-generating material as it is conveyed along the conveyance path and form it into a rod-like shape.

13. Apparatus according to claim 12, comprising a control unit configured to control the laser generator to cut the sheet into a plurality of parallel, elongate strips of aerosol-generating material that extend longitudinally in a direction extending along the conveyance path.

14. Apparatus according to claim 12, comprising a control unit configured to control the laser generator to intermittently cut the sheet to form discrete cut sections, each cut section being spaced from an adjacent cut section in a direction extending along the conveyance path.

15. Apparatus according to claim 14, wherein each discrete cut section comprises a plurality of parallel, elongate strips of aerosol-generating material extending in a direction along the conveyance path.

16. Apparatus according to claim 14, wherein the control unit is configured to control the laser generator to form a registration mark in the sheet.

17. Apparatus according to claim 16, comprising a scanner, said scanner being configured to read a registration mark and send a signal indicative of the presence of a registration mark to the control unit.

18. Apparatus according to claim 17, wherein the control unit is configured to control the consumable forming unit in dependence on said signal.

19. Apparatus according to claim 18, wherein the consumable forming unit comprises a garniture to wrap the sheet formed into a rod-like shape in a wrapper to form a wrapped rod, and a cutter to cut the wrapped rod into discrete rod sections.

20. Apparatus according to claim 19, wherein the control unit is configured to control the cutter that cuts the wrapped rod into discrete rod sections in dependence on said signal indicative of the presence of a registration mark.

21. A consumable comprising a sheet of aerosol-generating material formed into a wrapped rod and having a distal end for insertion into an aerosol generating device comprising a heating element that is received within the aerosol-generating material at distal end of the rod, wherein a portion of the sheet of aerosol generating material at the distal end of the rod is cut into strips extending from said distal end of the wrapped rod.

22. A non-combustible aerosol provision system comprising the consumable of claim 21 and an aerosol generating device comprising a heating element, the aerosol-generating device being configured to receive the consumable such that the heating element is received within the aerosol-generating material at the distal end of the rod.

23. A method of cutting a sheet of aerosol-generating material comprising:
conveying a sheet of aerosol-generating material along a conveyance path, and
making cuts in the sheet using a laser emitted by a laser generator as the sheet is conveyed along the conveyance path.

24. A method of manufacturing an aerosol-generating consumable from a sheet of aerosol-generating material, the method comprising:
conveying a sheet of aerosol-generating material along a conveyance path,
cutting the sheet of aerosol-generating material using a laser emitted by a laser generator as the sheet of aerosol-generating material is conveyed along the conveyance path, and
forming the cut sheet into a consumable in a consumable forming unit.

25. A method of manufacturing an aerosol-generating consumable according to claim 24, wherein the method comprises cutting the sheet using the laser generator to form discrete cut sections spaced from each other in a direction extending along the conveyance path, and so that each discrete cut section comprising a plurality of parallel, elongate strips of aerosol-generating material.
